(19) United States
(12) Patent Application Publication
(10) Pub. No.: US 2002/0139918 A1
(43) Pub. Date: Oct. 3, 2002

(54) Photo image detector and method of controlling luminous intensity therefor

(76) Inventors: Duck-Young Jung, Suwon-city (KR); Bang-Won Lee, Sungnam-city (KR)

Correspondence Address: CANTOR COLBURN, LLP, 55 GRIFFIN ROAD SOUTH, BLOOMFIELD, CT, 06002

(21) Appl. No.: 09/888,887

(22) Filed: Jun. 25, 2001

(30) Foreign Application Priority Data
Apr. 2, 2001 (KR) 2001-17349

(51) Int. Cl. G01J 1/32

(52) U.S. Cl. 250/205

(57) ABSTRACT

A photo image detector with a luminous intensity controller and a method of contolling a luminous intensity of a light source therefor. The photo image detector comprises a light source with a predetermined light quantity and for radiating light rays to an object, a photo image sensor which detects light rays reflected from the object and outputs a photo signal, an electric shutter which adjusts an exposing time interval according to the photo signal, and an image processor which receives the photo signal and outputting a photo image signal. The image processor including a luminous intensity controller for controlling a luminous intensity of the light rays which are radiated from the light source to the object according to the photo image signal. The photo image detector and the luminous intensity control method according to the present invention improves an image quality of the object by removing an image noise and a residual image caused by insufficient luminous intensity of the light source, and reduces a consumption of a power supply by adjusting directly the luminous intensity of the light source.

### BACKGROUND OF THE INVENTION

1. Field of the Invention

The present invention relates to a photo image detector, particularly to a photo image detector with a luminous intensity controller and a method of controlling a luminous intensity for the photo image detector.

2. Description of Related Art

In general, a photo image detector is applied to a digital camera, a video camera, a solid state imaging device, and a photo mouse, etc. The photo image detector includes a light device with a predetermined light quantity and detects a photo image of an object through reflected light rays when the light device irradiates the object.

As illustrated in FIG. 1, a conventional photo image detector receiving light rays reflected from an object 11 and detecting a photo image of the object includes a light source 10, a photo image sensor 12, an electric shutter 13, an analog to digital A/D converter 14, an image processor 15, and a system controller 16.

The light source 10 has a predetermined light quantity. The object 11 reflects incident light rays from the light source 10. The photo image sensor 12 detects light rays reflected from the object 11 and outputs a photocurrent or a photovoltage proportional to the incident light rays. The electric shutter 13 receives the photocurrent or a photovoltage outputted from the photo image sensor 12 and extracts a photo signal. The A/D converter 14 changes the photo signal extracted from the electric shutter 13 to a digital signal. The image processor 15 controls not only the digital signal converted in the A/D converter 14 to output a photo image signal, but also an exposing time of the electric shutter 13. The system controller 16 receives the photo image signal outputted from the image processor 15 to drive a system.

When the light quantity from the light source 10 is sufficient or a reflective ratio of the reflected light rays to the incident light rays at the object 11 is high, sufficient quantity of the reflected light rays can be inputted to the photo image sensor 12. Therefore, even though the electric shutter is exposed for a short time and the ratio of the photo signal to image noises inputted to the photo image sensor 12 is high, the conventional photo image detector is able to provide a stable image quality.

However, when an amount of light rays irradiated to the object 11 from the light source 10 is not sufficient, or a light absorptivity of the object 11 is high, an amount of the reflected light rays is not sufficient to be detected by the photo image sensor 12. In this case, an exposing time of the electric shutter 13 should be increased to receive a sufficient level of photocurrent/photovoltage from the photo image sensor 12 for a more exact image quality of the object 11 can be got.

As illustrated in FIG. 2, the light rays reflected from the object 11 activates a transistor Q1 through a photo diode PD in an integrated circuit with the photo image sensor 12 and the electric shutter 13. Then, the incident light rays are amplified in an amount of current amplification factor h_{fe} by the transistor Q1 and is transferred to the electric shutter 13.

A reset signal Rst and a shutter signal Sig from the system controller 16 or the image processor 15 are inputted to a reset terminal S-RST and the electric shutter 13 respectively. The reset signal Rst initializes a voltage of a capacitor C for a current/voltage conversion. The shutter signal Sig releases the initialized voltage by the photocurrent generated in the transistor Q1 for a photo signal.

When the shutter signal Sig interrupts a photocurrent path of the transistor Q1, the photo image is stored in the capacitor C and is transferred to the A/D converter 14 through a buffer 20.

Therefore, when a total quantity of the incident light rays to the photo image sensor 12 is not sufficient, the electric shutter 13 has a prolonged exposing time to accumulate sufficient quantity of the incident light rays to be converted to the photo image. In this case, a principle noise level is maintained by noise sources of the photo diode PD and the transistor Q1.

When the total quantity of the incident light rays is not sufficient, the quantity of the detected light rays is less than a target quantity of the light rays, the ratio of the reflected light rays to the noises is smaller than before, as illustrated in FIG. 6a.

To increase the ratio of the reflected light rays to the noises when the photo image is extracted, the prolonged exposing time is given to the electric shutter 13 to get a target distribution of the photo image level. However, as the exposing time gets longer, the noises are raised up, as illustrated in FIG. 6b. Therefore, the photo image and the noises are mixed up as illustrated in FIG. 7b.

A conventional camera has a problem of a residual image when an exposing time is increased. In a similar way, the photo image detector has the same problem of a residual image when an exposing time of the electric shutter 13 is increased. Such phenomena happen more severely when the photo image detector detects a photo image of a moving object as illustrated in FIG. 7a.

### SUMMARY OF THE INVENTION

To overcome the above described problems, a photo image detector with a luminous intensity controller is provided,.

Another aspect of the present invention provides a method of controlling a luminous intensity for a photo image detector, in which the luminous intensity of a light source is directly controlled according to a photo image reflected from an object.

In order to achieve the above object, the photo image detector comprises a light source with a predetermined light quantity and for radiating light rays to an object, a photo image sensor which detects light rays reflected from the object and outputs a photo signal, an electric shutter which adjusts an exposing time interval according to the photo signal, an image processor which receives the photo signal and outputting a photo image signal. The image processor comprises a luminous intensity controller for controlling a luminous intensity of the light rays which are radiated from the light source to the object.

According to another embodiment of the present invention, the luminous intensity controller is included in a system controller.

The method of controlling a luminous intensity for a photo image detector comprises radiating light rays from a light source to an object, detecting control method of a photo image detector, which detects an incident light rays reflected from an object through an image sensor and an electric shutter. As a result, either an image processor or a system controller controls directly luminous intensity of the light source according to the quantity of the detected light rays.

### BRIEF DESCRIPTION OF THE DRAWINGS

For a more complete understanding of the present invention and the advantages thereof, a preferred embodiment of the present invention will be described with reference to the attached drawings, in which like reference numerals denote like parts, and in which:

FIG. 1 is a block diagram illustrating a conventional photo image detector and a luminous intensity control method for the conventional photo image detector;

FIG. 2 is a circuit diagram illustrating a conventional photo image sensor;

FIG. 3 is a block diagram of a photo image detector and a luminous intensity control method therefor according to one embodiment of the present invention;

FIG. 4 is a block diagram illustrating another embodiment of a photo image detector and a luminous intensity control method therefor according to the present invention;

FIG. 5 is a circuit diagram of an image sensor according to the present invention;

FIG. 6a and FIG. 6b are waveform diagrams illustrating a distribution change of a target luminous intensity and of a noise level when the exposing time is increased in the conventional photo image detector;

FIG. 6c and FIG. 6d are waveform diagrams illustrating a distribution change of a target luminous intensity and a noise level when the exposing time is increased, according to the present invention;

FIG. 7a and FIG. 7b are image diagrams illustrating a residual image and a noise image when the photo image detector detects an image of a moving object in the conventional photo image detector; and

FIG. 7c and FIG. 7d are image diagrams illustrating a residual image and a noise image when the photo image detector detects an image of a moving object according to the present invention.

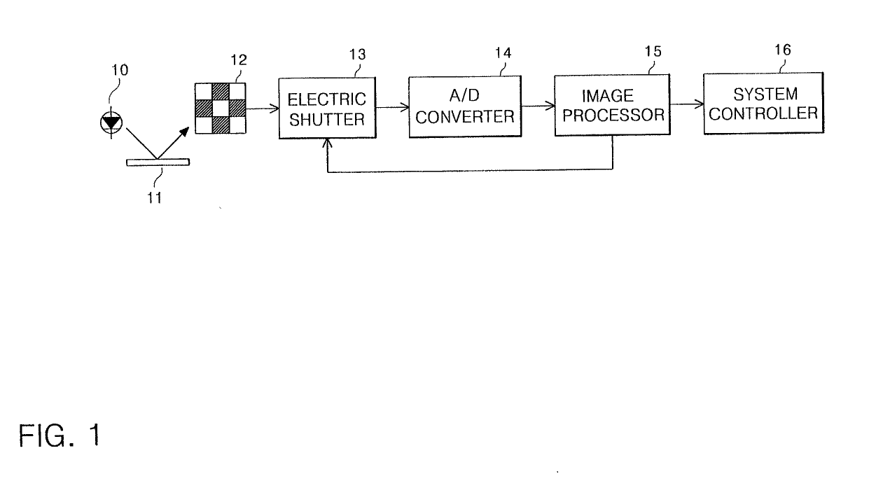

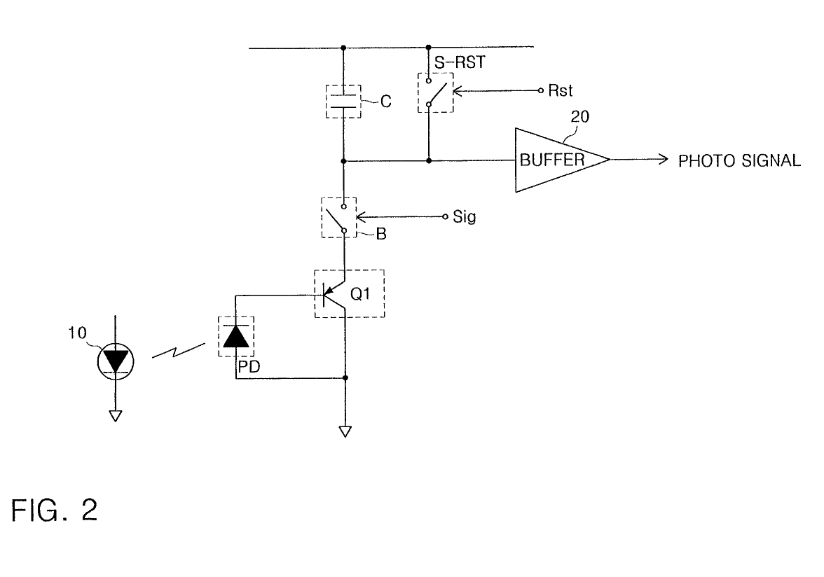

### DETAILED DESCRIPTION OF PREFFERED EMBODIMENTS

Reference will now be made in detail to preferred embodiments of the present invention.

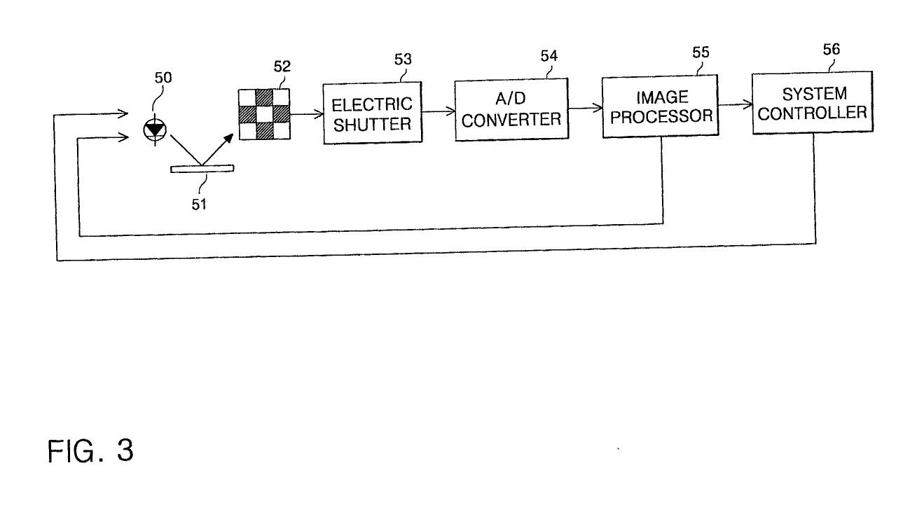

FIG. 3 is a block diagram illustrating one embodiment of a photo image detector and a luminous intensity control method therefor according to the present invention. The photo image detector includes a light source 50, a photo image sensor 52, an electric shutter 53, an A/D converter 54, an image processor 55, and a system controller 56.

The light source 50 has a predetermined light quantity. An object 51 reflects light rays radiated from the light source 50. The photo image sensor 52 detects the reflected light rays from the object 51 and outputs a photo signal in a form of a photocurrent or a photovoltage proportional to the reflected light rays. The electric shutter 53 adjusts an exposing time interval according to the photocurrent or the photovoltage and extracts the photo signal. The A/D converter 54 converts the photo signal extracted through the electric shutter 53 to a digital signal. The image processor 55 receives the digital signal from the A/D converter 54 and outputs a photo image signal. The system controller 56 receives the photo image signal to drive a system.

According to the present invention, the image processor comprises a luminous intensity controller which outputs a control signal according to the photo image signal, and controls directly luminous intensity of the light source 50.

According to another embodiment of the present invention, the system controller comprises a luminous intensity controller which outputs a control signal to control directly luminous intensity of the light source.

The luminous intensity controller employs a pulse width modulation PWM or a pulse duration modulation PDM, and controls directly the luminous intensity of the light source 50. Also, the luminous intensity controller employs a current or a voltage to directly control the luminous intensity of the light source 50. Additionally, the system controller 56 can convert one of the signals PWM, PDM, a current, and a voltage to an output signal of the system controller 56, and directly control the luminous intensity of the light source 50.

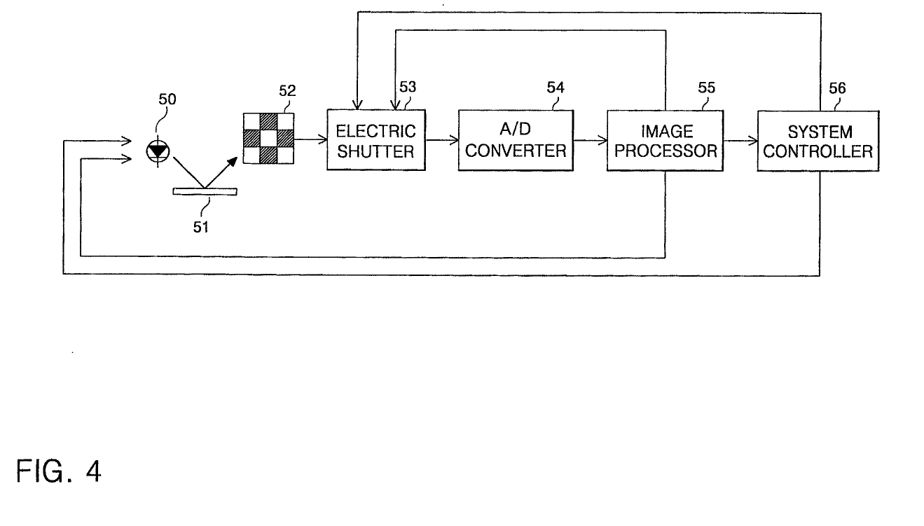

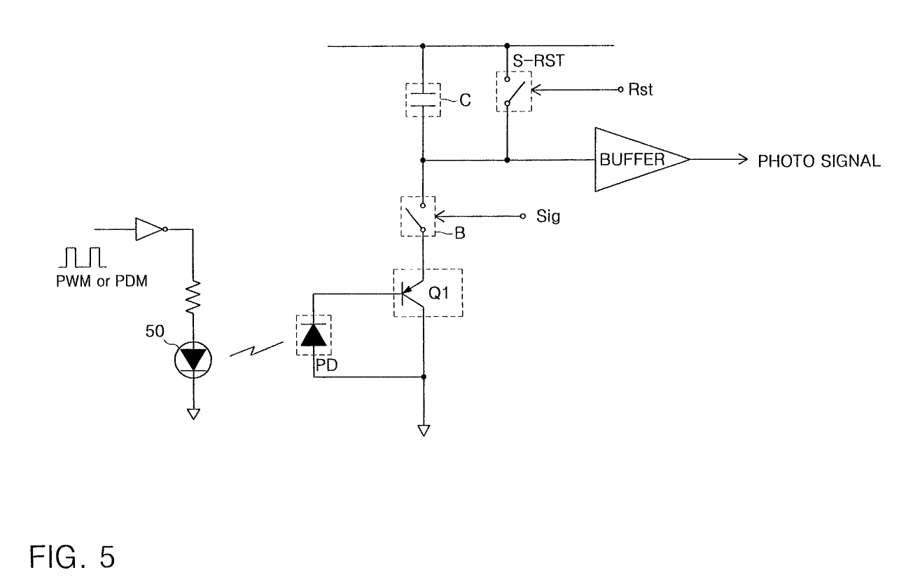

FIG. 4 is a block diagram illustrating another embodiment of a photo image detector and a method of controlling a luminous intensity therefore according to the present invention. As illustrated in FIG. 4, a predetermined control signal outputted from the luminous intensity controller in the image processor 55 controls the luminous intensity of the light source 50 and the exposing time of the electric shutter 53. The driving method for the photo image detector will be described in detail.

The light source 50 receives a predetermined luminosity control signal from the luminous intensity controller in the image processor 55 or the system controller 56 and radiates light rays to the object 51. The object 51 receives the light rays from the light source and reflects light rays. The light rays reflected from the object 51 are inputted to the image sensor 52.

Then, the image sensor 52 accumulates light rays for a predetermined exposing time interval adjusted through the electric shutter 53 for a predetermined level of a photo signal, and the photo signal is inputted to the A/D converter 54.

The A/D converter 54 converts the photo signal to a digital signal and outputs the digital signal to the image processor 55. The image processor 55 receives the digital signal to output a photo image signal, and the luminous intensity controller receives the photo image signal including a pulse modulation signal PWM or a PDM to output a luminous intensity control signal to adjust the luminous intensity of the light source 50.

When the luminous intensity of the light source 50 is suitable so that the image processor 55 can produce a photo image signal so as to give a predetermined quality of a photo image of the object 51, the luminosity signal for adjusting the luminous intensity of the light source 50 is not changed.

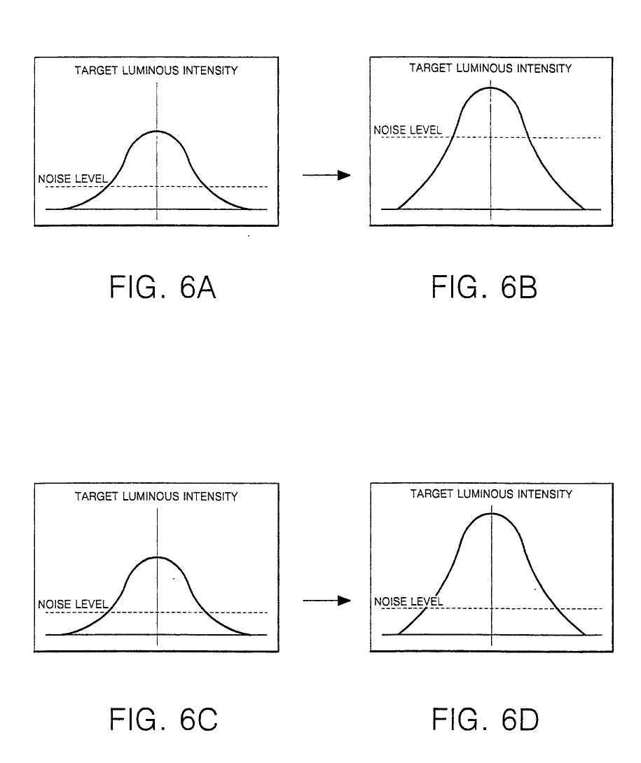

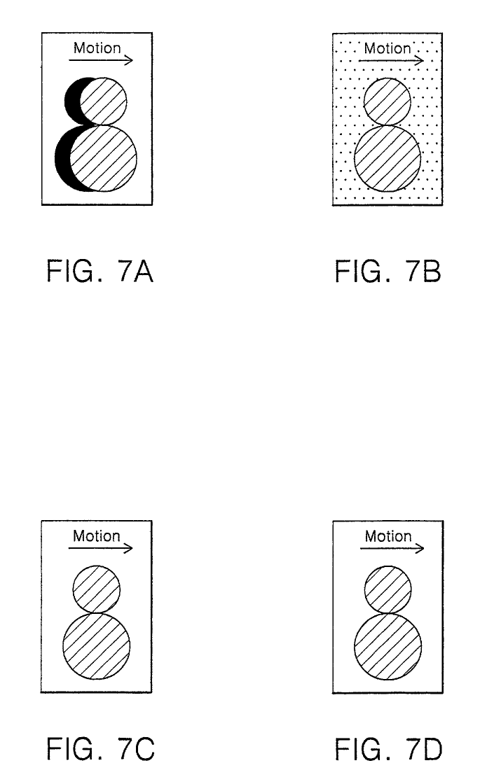

On the contrary, when the luminous intensity of the light source 50 needs to be changed, the luminous intensity controller employs one of the signals PWM, PDM, a current, and a voltage outputted from the image processor 55 and output a luminous intensity control signal to the light source 50 to control a power pulse applied to the light source 50. As illustrated in FIG. 6d, the luminous intensity alone is raised up to a target value while a noise is retained in a value as before. Therefore, a photo image of the object without a noise and without a residual effect can be achieved, specially, when the photo image detector detects an image of a moving object, as illustrated in FIG. 7c and FIG. 7d.

In another preferred embodiment of the present invention, the luminous intensity controller in the image processor 55 or in the system controller 56 outputs directly one of the signals PWM, PDM, a current, and a voltage as a control signal not only to the light source 50, but also to the electric shutter 53. Therefore, by adjusting both the luminous intensity of the light source 50 and the exposing time of the electric shutter 53, a image noise and a residual image can be removed and special effects, such as an intentional distortion to an image and a residual effect can be controlled.

Therefore, the photo image detector according to the present invention provides an enhanced quality of a photo image of an object by controlling the luminous intensity of the light source. Also, the luminous intensity control method for a photo image detector according to the present invention improves an image quality of an object by removing an image noise and a residual image caused by insufficient luminous intensity of a light source, and reduces a consumption of a power supply by adjusting directly the luminous intensity of the light source.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A photo image detector comprising:
a light source with a predetermined light quantity and for radiating light rays to an object;
a photo image sensor which detects light rays reflected from the object and outputs a photo signal;
an electric shutter which adjusts an exposing time interval according to the photo signal; and
an image processor which receives the photo signal and outputting a photo image signal, the image processor including a luminous intensity controller for controlling a luminous intensity of the light rays which are radiated from the light source to the object according to the photo image signal.

2. The photo image detector of claim 1, further comprising an A/D converter which converts the photo signal in a digital form.

3. The photo image detector of claim 1, further comprising a system controller to drive the photo image detector.

4. The photo image detector of claim 1, wherein the photo signal is a form of a photocurrent or a photovoltage.

5. The photo image detector of claim 1, wherein the luminous intensity controller receives at least one of signals including a pulse width modulation, a pulse duration modulation, a photocurrent and a photovoltage and outputs the received at least one signal as a luminous intensity control signal.

6. The photo image detector of claim 1, wherein the luminous intensity controller further controls the electric shutter to adjust the exposing time interval.

7. A photo image detector comprising:
a light source with a predetermined light quantity and for radiating light rays to an object;
a photo image sensor which detects light rays reflected from the object and outputs a photo signal;
an electric shutter which adjusts an exposing time interval according to the photo signal;
an image processor which receives the photo signal and outputting a photo image signal; and
a system controller including a luminous intensity controller for controlling the light rays which are radiated from the light source to the object according to the photo image signal.

8. The photo image detector of claim 1, further comprising an A/D converter which converts the photo signal in a digital form.

9. The photo image detector of claim 1, wherein the photo signal is a form of a photocurrent or a photovoltage.

10. The photo image detector of claim 1, wherein the luminous intensity controller receives at least one of signals including a pulse width modulation, a pulse duration modulation, a photocurrent and a photovoltage and outputs the received at least one signal as a luminous intensity control signal.

11. The photo image detector of claim 1, wherein the luminous intensity controller further controls the electric shutter to adjust the exposing time interval.

12. A method of controlling a luminous intensity for a photo image detector comprising a light source with a predetermined light quantity and for radiating light rays to an object, a photo image sensor for detecting light rays reflected from the object and outputting a photo signal, an electric shutter for adjusting an exposing time interval according to the photo signal, and an image processor which receives the photo signal and outputting a photo image signal, the method comprising:
the image processor producing a luminous intensity control signal; and
controlling directly a luminous intensity of the light source by the luminous intensity control signal.

13. The method of claim 12, wherein the image processor outputs at least one of signals of a pulse width modulation PWM and a pulse duration modulation PDM as the luminous intensity control signal.

14. The method of claim 12, wherein the image processor produce the luminous intensity control signal by employing a current or a voltage.

15 The method of claim 12, further comprising producing an exposing time interval control signal by the photo imageprocessor to directly control the electric shutter.

16. The method of claim 15, wherein the exposing time interval time control signal is outputted by using at least one of a pulse width modulation PWM, a pulse duration modulation PDM, a photocurrent and a photovoltage.

17. A method of controlling a luminous intensity for a photo image detector comprising a light source with a predetermined light quantity and for radiating light rays to an object, a photo image sensor for detecting light rays reflected from the object and outputting a photo signal, an electric shutter for adjusting an exposing time interval according to the photo signal, an image processor which receives the photo signal and outputting a photo image signal, and a system controller to drive the photo image detector, the method comprising:
the system controller producing a luminous intensity control signal; and
controlling directly a luminous intensity of the light source by the luminous intensity control signal.

18. The method of claim 17, further comprising producing an exposing time interval control signal by the system controller to directly control the electric shutter.

19. The method of claim 17, wherein the luminous intensity control signal is outputted by using at least one of a pulse width modulation PWM, a pulse duration modulation PDM, a photocurrent and a photovoltage.

20. The method of claim 18, wherein the exposing time interval control signal is outputted by using at least one of a pulse width modulation PWM, a pulse duration modulation PDM, a photocurrent and a photovoltage.
